(19) United States
(12) Patent Application Publication
(10) Pub. No.: US 2011/0133414 A1
(43) Pub. Date: Jun. 9, 2011

(54) GASKET UNIT

(75) Inventor: Phil Gi Lee, Suwon-city (KR)

(73) Assignees: Hyundai Motor Company, Seoul (KR); Kia Motors Corporation, Seoul (KR)

(21) Appl. No.: 12/896,171

(22) Filed: Oct. 1, 2010

(30) Foreign Application Priority Data
Dec. 3, 2009 (KR) 10-2009-0119367

(51) Int. Cl. F02F 11/00

(52) U.S. Cl. 277/594

(57) ABSTRACT

A gasket unit, in which a first hole and a second hole are formed corresponding to a first cylinder and a second cylinder adjacent to each other, may include a bore bridge portion formed between the first hole and the second hole. The bore bridge portion may be made up of a single plate and may include a wave portion that is convex downwards or upwards, and at least a stopper protruding on an upper surface or a lower surface of both distal ends of the wave portion.

### CROSS-REFERENCE TO RELATED APPLICATION

The present application claims priority to Korean Patent Application No. 10-2009-0119367 filed in the Korean Intellectual Property Office on Dec. 3, 2009, the entire contents of which is incorporated herein for all purposes by this reference.

### BACKGROUND OF THE INVENTION

1. Field of the Invention

The present invention relates to a gasket unit. More particularly, the present invention relates to a gasket unit that is disposed between a cylinder head and a cylinder block of an engine to perform a sealing function.

2. Description of Related Art

Generally, a gasket compensates for an irregular surface between two metal surfaces to prevent oil or coolant from leaking. A head gasket mounted in an engine sustains combustion pressure within a cylinder.

Further, the gasket reduces noise as a damper, functions as a spacer, and functions as an insulator. The gasket can be made of steel, copper, fiber, cork, rubber, silicone, graphite, and so on.

However, in a case that the gasket is interposed between the cylinder block and the cylinder head of an engine, as engines are becoming more compact, the distance between two adjoining cylinders and the width of a bore bridge of the gasket are decreased, so a gasket that can securely seal a small bore bridge has been receiving research attention.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a cylinder gasket having advantages of securely sealing a bore bridge between two adjoining cylinders.

In an aspect of the present invention, the gasket unit, in which a first hole and a second hole are formed corresponding to a first cylinder and a second cylinder adjacent to each other may include a bore bridge portion formed between the first hole and the second hole and made up of a single plate, wherein the bore bridge portion may have a wave portion that is convex downwards or upwards, and at least a stopper protruding on an upper surface or a lower surface of both distal ends of the wave portion.

The wave portion may include a lower land, of which a lower surface contacts an upper surface of a cylinder block, first and second slanting lands that integrally extend from both distal ends of the lower land to be slanted upwards, and first and second upper lands that integrally extend from both distal ends of the first and second slanting lands respectively, wherein an upper surface thereof contacts a lower surface of a cylinder head.

A groove may be formed at an opposite side of the at least a stopper, wherein the at least a stopper includes a first lower stopper, and the first lower stopper and a first lower groove are sequentially formed on a lower surface of the first upper land from the lower land to the first hole, and a first upper groove is formed corresponding to the first lower stopper in the first upper land and a first upper stopper is formed corresponding to the first lower groove adjacent to the first upper groove.

A lower surface of the first lower stopper, which protrudes in a lower direction of the first upper land, may be disposed higher than the lower surface of the lower land by a predetermined gap, and an upper surface of the first upper stopper, which protrudes in an upper direction, and the upper surface of the first upper land, may have the same height.

The at least a stopper may include a second lower stopper, and the second lower stopper and a second lower groove are sequentially disposed on a lower surface of the second upper land from the lower land to the second hole, and a second upper groove is formed corresponding to the second lower stopper and a second upper stopper is formed corresponding to the second lower groove adjacent to the second upper groove, wherein a lower surface of the second lower stopper, which protrudes in an lower direction, is disposed higher than the lower surface of the lower land by a predetermined gap and an upper surface of the second upper stopper which protrudes in an upper direction, has the same height as an upper surface of the second upper land.

An upper surface of the at least a stopper, which protrudes in an upper direction, and the upper surface of the first and second upper lands, may have the same height.

A lower surface of the at least a stopper, which protrudes in a lower direction, may be disposed higher than the lower surface of the lower land by a predetermined gap.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic top plan view of an exemplary gasket unit according to an exemplary embodiment of the present invention.

FIG. 2 is a partial cross-sectional view of a gasket unit along A-A line of FIG. 1.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

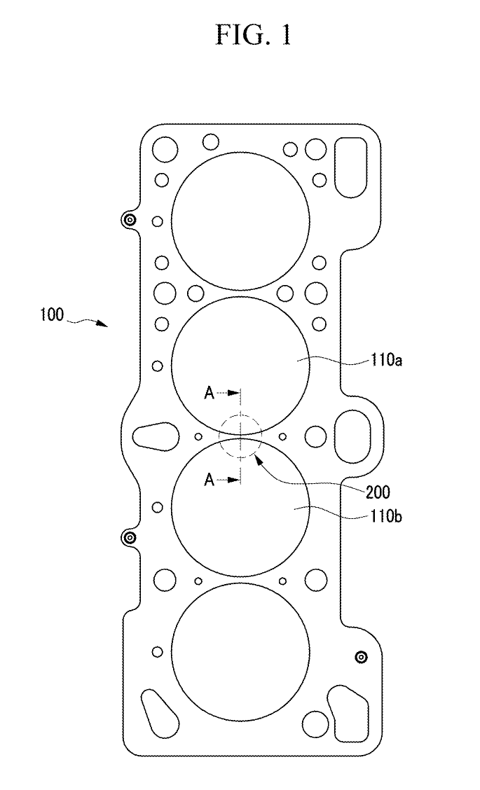

FIG. 1 is a schematic top plan view of a gasket unit according to an exemplary embodiment of the present invention.

Referring to FIG. 1, the gasket unit 100 is interposed between a cylinder block 10 and a cylinder head 20, and four holes are formed in the gasket unit 100 corresponding to four cylinders.

The gasket unit 100 according to an exemplary embodiment of the present invention can be applied to two cylinders, three cylinders, four cylinders, six cylinders, eight cylinders, ten cylinders, twelve cylinders, and so on, and the number of cylinders is not limited.

A first hole 110a corresponding to the second cylinder is formed and a second hole 110b corresponding to the third cylinder is formed in the gasket unit 100, and a bore bridge portion 200 is formed between the first hole 110a and the second hole 110b.

While the width of the bore bridge portion 200 is narrow, the sealing structure needs to be strong, since the second cylinder and the third cylinder adjoin each other.

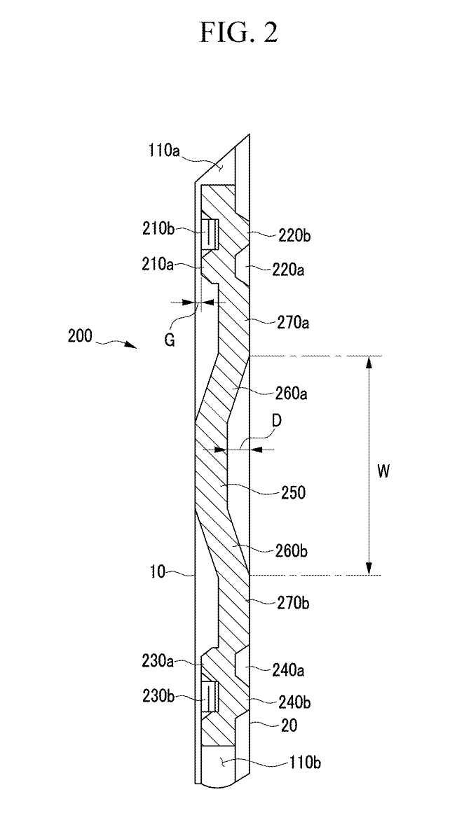

FIG. 2 is a partial cross-sectional view of a gasket unit along the A-A line of FIG. 1.

Referring to FIG. 2, the bore bridge portion 200 includes a lower land 250 corresponding to the upper surface of the cylinder block 10, a first slanting land 260a and a second slanting land 260b that are integrally formed with both end parts of the lower land 250 to be slant upwards, and a first upper land 270a and a second upper land 270b that are integrally formed with the first and second slanting lands 260a and 260b and of which the upper surface corresponds to the lower surface of the cylinder head.

In the present invention, with regard to the lower surface and the upper surface of the gasket unit 100, they can be conversely positioned.

A first depth (D) is formed from the upper surface of the first and second upper lands 270a and 270b to the upper surface of the lower land 250, and it is desirable that a first width (W) of the lower land 250 and the first and second slanting lands 260a and 260b is more than twice the first depth (D).

That is, if the first depth (D) becomes longer compared with the first width (W), the surface pressure of the bore bridge portion 200 between the cylinder head 20 and the cylinder block 10 is suddenly varied, such that a crack can be formed in the gasket.

A first lower stopper 210a and a first lower groove 210b are sequentially formed at a lower surface of the first upper land 270a from the lower land 250 to the first hole 110a direction, and a first upper groove 220a corresponding to the first lower stopper 210a and a first upper stopper 220b corresponding to the first lower groove 210b are formed at an upper surface of the first upper land 270a.

A second lower stopper 230a and a second lower groove 230b are sequentially formed from the lower land 250 to the second hole 100b direction at a lower surface of the second upper land 270b, and a second upper groove 240a corresponding to the second lower stopper 230a and a second upper stopper 240b corresponding to the second lower groove 230b are formed at an upper surface of the second upper land 270b.

The gasket unit 100 according to an exemplary embodiment of the present invention is composed of a single plate, and is distinguished from other gaskets that are made up of several stacked plates.

Referring to FIG. 2, the upper surface of the first upper land 270a and the upper end surface of the first upper stopper 220b have the same level, and the upper surface of the second upper land 270b and the upper end surface of the second upper stopper 240b have the same level. Accordingly, adherence force with the lower surface of the cylinder head 20 is improved.

There is a difference in height between the lower surface of the lower land 250 and the lower end surface of the first lower stopper 210a of the first upper land 270a, and the lower end surface of the first lower stopper 210a is higher than the lower surface of the lower land 250 by a first gap (G). Further, it is desirable that the lower end surface of the second lower stopper 230a is higher than the lower surface of the lower land 250 by the first gap (G).

Due to the first gap (G), the lower land 250 firstly adheres to the upper surface of the cylinder block 10, the first and second slanting lands 260a and 260b are transformed horizontally, and the first lower stopper 210a contacts the upper surface of the cylinder block 10 to be fixed thereto.

Referring to FIG. 2, a single wave portion, which is convex downwards, is formed in the bore bridge portion, and the wave portion includes the lower land 250 and the first and second slanting lands 260a and 260b.

Further, in an exemplary embodiment of the present invention, the height of the stopper is about 120 μm and the height of the stopper except the bore bridge portion is about 105 μm in the gasket unit so as to improve sealing performance of the bore bridge portion.

Referring to FIG. 2, the wave portion, which is convex downwards or upwards, is formed in the bore bridge portion of the gasket unit according to an exemplary embodiment of the present invention, and the wave portion includes the lower land 250, the first slanting land 260a, and the second slanting land 260b. Further, the wave portion can be formed in a lower direction or an upper direction of the gasket.

For convenience in explanation and accurate definition in the appended claims, the terms “upper” and “lower”are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gasket unit, in which a first hole and a second hole are formed corresponding to a first cylinder and a second cylinder adjacent to each other, and a bore bridge portion is formed between the first hole and the second hole and made up of a single plate, wherein the bore bridge portion comprises:
a wave portion that is convex downwards or upwards; and
at least a stopper protruding on an upper surface or a lower surface of both distal ends of the wave portion.

2. The gasket unit of claim 1, wherein the wave portion includes:
a lower land, of which a lower surface contacts an upper surface of a cylinder block;
first and second slanting lands that integrally extend from both distal ends of the lower land to be slanted upwards; and
first and second upper lands that integrally extend from both distal ends of the first and second slanting lands respectively, wherein an upper surface thereof contacts a lower surface of a cylinder head.

3. The gasket unit of claim 2, wherein a groove is formed at an opposite side of the at least a stopper.

4. The gasket unit of claim 3, wherein the at least a stopper includes a first lower stopper, and the first lower stopper and a first lower groove are sequentially formed on a lower surface of the first upper land from the lower land to the first hole, and a first upper groove is formed corresponding to the first lower stopper in the first upper land and a first upper stopper is formed corresponding to the first lower groove adjacent to the first upper groove.

5. The gasket unit of claim 4, wherein a lower surface of the first lower stopper, which protrudes in a lower direction of the first upper land, is disposed higher than the lower surface of the lower land by a predetermined gap, and an upper surface of the first upper stopper, which protrudes in an upper direction, and the upper surface of the first upper land, have the same height.

6. The gasket unit of claim 3, wherein the at least a stopper includes a second lower stopper, and the second lower stopper and a second lower groove are sequentially disposed on a lower surface of the second upper land from the lower land to the second hole, and a second upper groove is formed corresponding to the second lower stopper and a second upper stopper is formed corresponding to the second lower groove adjacent to the second upper groove.

7. The gasket unit of claim 6, wherein a lower surface of the second lower stopper, which protrudes in an lower direction, is disposed higher than the lower surface of the lower land by a predetermined gap and an upper surface of the second upper stopper which protrudes in an upper direction, has the same height as an upper surface of the second upper land.

8. The gasket unit of claim 3, wherein an upper surface of the at least a stopper, which protrudes in an upper direction, and the upper surface of the first and second upper lands, have the same height.

9. The gasket unit of claim 3, wherein a lower surface of the at least a stopper, which protrudes in a lower direction, is disposed higher than the lower surface of the lower land by a predetermined gap.
